(19) United States
(12) Patent Application Publication
(10) Pub. No.: US 2007/0176143 A1
(43) Pub. Date: Aug. 2, 2007

(54) Stable ill-defined cubic nanosized particles in a ternary aqueous phase

(75) Inventors: Nissim Garti, Jerusalem (IL); Rivka Efrat, Rosh Ha'ayin (IL); Avraham Aserin, Jerusalem (IL)

Correspondence Address: NATH & ASSOCIATES, 112 South West Street, Alexandria, VA, 22314, US

(73) Assignee: YISSYM RESEARCH DEVELOPMENT COMPANY OF THE HEBREW UNIVERSITY OF JERUSALEM, JERUSALEM (IL)

(21) Appl. No.: 10/584,993

(22) PCT Filed: Dec. 30, 2004
(86) PCT No.: PCT/IL04/01188

§ 371 Date: Jan. 3, 2007

Related U.S. Application Data
(60) Provisional application No. 60/533,230, filed on Dec. 31, 2003.

(51) Int. Cl. C09K 19/52

(52) U.S. Cl. 252/299.01

(57) ABSTRACT

The present invention concerns ternary system comprising 40 to 65% water; 6 to 22% alcohol or a ketone; and 25 to 60% a fatty acid or an ester thereof forming spontaneously a stable, non-viscous and clear nanosized structures having cubic-like nanosized symmetry. The ternary system may be dispersed and used as a solubilizing medium for hydrophobic and hydrophilic substances.

### FIELD OF THE INVENTION

The present invention relates to a stable semi-ordered ill-defined single phase with cubic symmetry in a ternary aqueous system.

### BACKGROUND OF THE INVENTION

Micelle microemulsions (water/oil, bicontinuous, oil/water) and lyotropic liquid crystals are some of the well-known and well-studied phases that amphiphilic entities adopt when they are in aqueous vicinity. Lyotropic liquid crystalline mesophases (lamellar, hexagonal reverse hexagonal, cubic etc.) are well characterized and employed in numerous applications. Within the large family of liquid crystalline phases, the bicontinuous cubic phase has attracted much attention since its first description (Luzzati, V., Tardieu, A., Gulik-Kryzwicki, T,. Rivas, E., Reiss-Husson, F. (1968) Nature 220, 485). It is well-defined and characterized by spectroscopic and spectophotometric measurements. Its small angle X-ray scattering and ¹³C NMR spectroscopy are given in Minoru, N., Atsuhiko, S., Hideki, M., Tetsurou, H. (2001) Langmuir 17, 3917. A review by one of the inventors of the present invention, titled “Bicontinuous Liquid Crystalline Mesophases-solubilization Reactivity and Interfacial Reactions” recently sent to publication, summarizes its vast use in research and furthermore, its potential use as a substitute for solubilizing hydrophilic and hydrophobic materials for sustained and controlled release. The latter use of the cubic phase is attributed to its extremely large surface area, well organized microstructure. However, like all liquid crystalline phases, the semisolid or gel-like macrostructure can not be used as is for solubilizing hydrophilic and hydrophobic material because it is glassy and non-dispersible and therefore the cubic phase should be diluted or dispersed in an appropriate aqueous system and solvent. Dilution and dispersion were successfully done where they involve use of additional specific (mostly polymer) hydrophilic surfactant and co-solvent like alcohol or some other high shear force. Dilution should be done cautiously, since it may result in disruption of the microscopic “order” and at high dilution ratios may completely distort microscopic structure leading to loss of their unique character.

### SUMMARY OF THE INVENTION

The present invention is based on the fact that ternary systems comprising water, fatty acid or an ester thereof, and a co-solvent such as alcohol, ketone, organic acid or amino acid may form spontaneously a stable, non-viscous and clear nanosized structures having cubic-like nanosized symmetry. The ternary system being a single phase is created in well-defined concentrations of the three components of the system. Outside the boundaries of these relative concentrations, other known single phase or biphasic solutions prevail (non-continuous, two-phase, etc.). The spontaneously formed ternary system is capable of being diluted or dispersed in a water/polymer at room temperature and/or 9000 rpm to form dispersed cubic-like nanosized particles. In the dispersed cubic-like nanosized particles hydrophilic, hydrophobic, non-water or non-oil soluble substances can efficiently be solubilized .

Thus according to a first embodiment the present invention is directed to a ternary system comprising:

(i) 40 to 65% water;

(ii) 6 to 22% an alcohol or a ketone; and

(iii) 25 to 60% fatty acid or an ester thereof.

The alcohol is a C₁-C₈ alcohol or a polyalcohol. Preferably the alcohol is ethanol, propanol or butanol or polyethylene glycol. The ketone is linear or cyclic C₃-C₈ ketone which may comprise a heteroatom such as nitrogen, oxygen or sulfur. Preferably the ketone is a cyclic ketone having one heteroatom. The fatty acid is a C₂-C₂₂ saturated or unsaturated fatty acid wherein the unsaturated fatty acid may contain one or more double bonds. The fatty acid ester may be with a regular alcohol or a polyalcohol such as glycerol, sorbitol, propylene glycol, polyglycerol, sorbitan, polyethylene glycol. Preferably it is glycerol esters of fatty acids. Most preferably it is glycerol monooleate or a mixture of monooleate and monostearate or any partially hydrogenated monoglycerol of vegetable oils.

The present invention according to a second embodiment is further directed to ternary system comprising water, fatty acid or an ester thereof and alcohol or a ketone, forming spontaneously a stable, non-viscous and clear nanosized structures having cubic-like nanosized symmetry for use in solubilizing hydrophilic, hydrophobic, or non-water or non-oil soluble substances. The spontaneously formed ternary system is capable of being diluted or dispersed in a water/polymer at room temperature and/or 200-20000 preferably 9000 rpm to form dispersed cubic-like nanosized particles which are used for solubilizing hydrophilic, hydrophobic or non-water or non-oil soluble substances. Such substances may be enzymes vitamins, pharmaceuticals, peptides, food supplements or cosmetoceuticals.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is phase diagram of a ternary aqueous phase system comprising water, ethanol and glycerol monooleate; (A) of the prior art showing the various ordered and semi-ordered structures as a function of the relative concentrations of each of the three components comprising the system; (B) of the present invention where in addition to the known ordered phases from the prior art, a semi-ordered phase herein defined as Q_{L} phase is present.

FIG. 2 is phase diagram of a ternary aqueous phase system comprising water, ethanol and glycerol monooleate as shown in FIG. 1B where the external boundaries depicted D, E and F, S₄ and S₅ of the formed Q_{L} phase are demonstrated, as well as the E the S₀ within the Q_{L} phase.

FIG. 3(A) shows freeze-fracture electron microscope (cryo-TEM) image of the Q_{L} phase of the present invention (Example 1) where different levels of organizations are observed. (B) Shows the cubic organization.

FIG. 4 is the FFT (Fourier Transform) of the cryo-TEM image shown in FIG. 3A showing different geometrical organizations in the system.

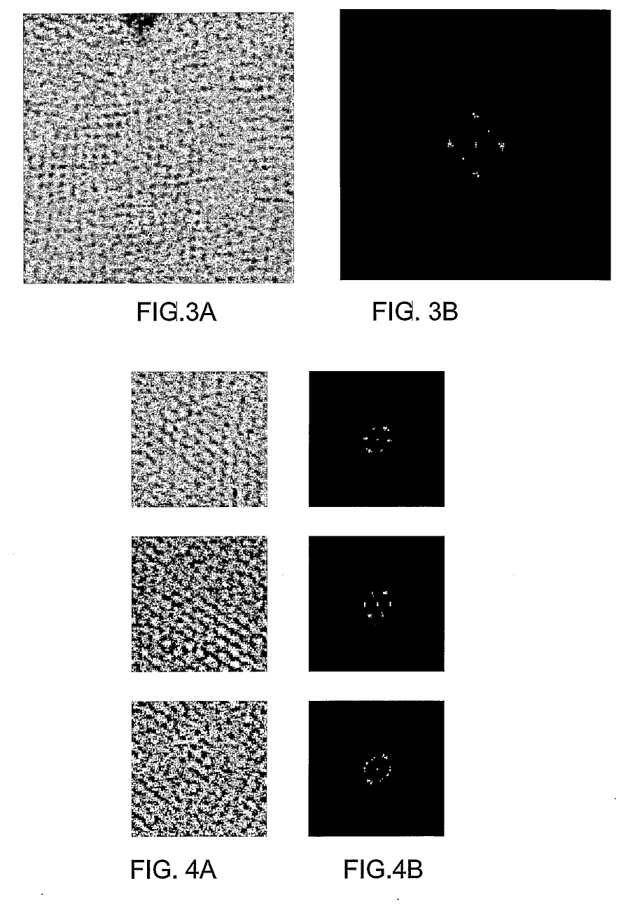

FIG. 5 is a SAXS (Small Angle X-ray diffraction) diffraction of three different compositions within the Q_{L} domain differing in their water/ethanol/GMO contents (as indicated above each of the demonstrated diffractions).

FIG. 6 is a SAXS diffraction of four points having a water contents of 50, 51, 52 and 53% (w/w) taken from the Q_{L} region.

FIG. 7 is a SAXS diffraction of several different compositions varying in their alcohol contents where the water:fatty acid (or ester thereof) is kept constant (designated S₂, S₃, S₄ and S₅ in FIG. 2)

FIG. 8(A) is a cryo-TEM of a Q_{L} phase containing 36.1 wt % GMO; 11.5 wt % ethanol; and 52.4 wt % water (B) is the FFT showing the cubic organization of the phase.

FIG. 9(A) is a cryo-TEM of a Q_{L} phase containing 38.3 wt % GMO; 11.2 wt % ethanol; and 50.5 wt % water (B) is the FFT showing the cubic organization of the phase.

FIG. 10(A) is the SAXS diffraction of a system comprising water:2-pyrrolidone:GMO at a ratio of 50 wt %:20 wt %: 30 wt % (B) is cryo-TEM of the Q_{L} phase formed by the system described in (A) after it has been dispersed in a polymer. The figure showing an enlargement of a cubic phase island (C) is a cryo-TEM of the system described in (A) and its FFT showing cubic organization.

FIG. 11(A) is the SAXS diffraction of a system comprising water:propanol:GMO at a ratio of 55.1 wt %:8.3 wt %: 36.6 wt % (B) is a cryo-TEM of the system described in (A) and its FFT showing cubic organization.

FIG. 12 shows an isotherm of electrical conductivity as a function of the water contents along the dilution line 8:2 showing an increase in conductivity with increase of the water contents and further with change from phase to phase.

FIG. 13 shows the results of a LUMiFuge instructor demonstrating that the stability over time (self life) of the Q_{L} phase is about the same as that of a micellar phase.

### DETAILED DESCRIPTION OF THE INVENTION

The invention will now be described with reference to some non-limiting specific embodiments. The invention will first be illustrated in reference to the attached drawings to be followed by a more detailed description below.

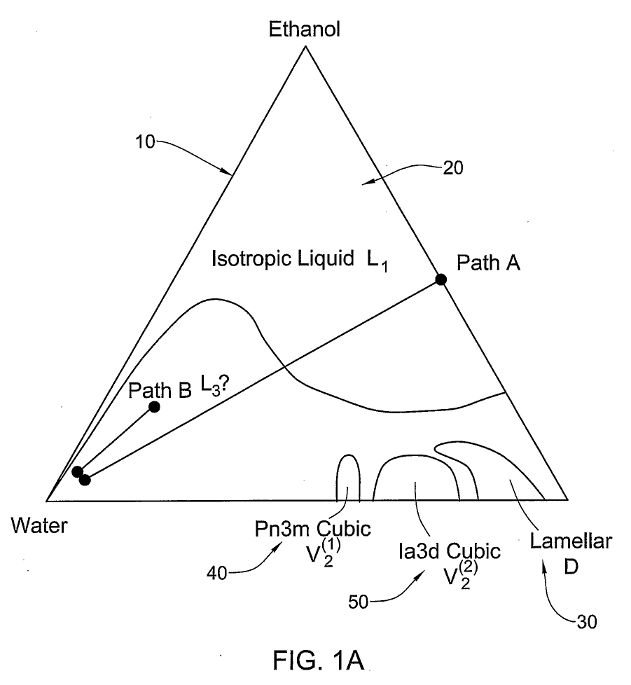

A well known and characterized cubic phase is formed (among other phases) by mixing glycerol monooleate with water. Upon addition of a diluting co-emulsifier or co-solvent such as an alcohol (mono- or poly-alcohol) one obtains a ternary phase diagram 10 (FIG. 1A) exhibiting several phase regions. As displayed in the ternary phase diagram 10 several phases exist within the dilution boundaries. An isotropic phase at 20, a lamellar phase at 30 and two well-characterized cubic phases at 40 (diamond bicontinuous Pn3m) and 50 (gyroid bicontinuous Ia3d). The formed cubic phase is a viscous clear bulk. The main bicontinuous cubic phases may be characterized by dispersing the formed cubic phase, for example by addition of a polymer/water (excess water) forming cubosomes. The formed cubosomes are characterized by their small angle X-ray, particle size and their characteristic cryo-Transmission Electron Microscopy (cryo-TEM) images.

Turning to FIG. 1B there is described a phase diagram of a ternary aqueous system 60 exemplifying the present invention comprising of water, glycerol monooleate (GMO) and ethanol. As mentioned above, GMO forms lyotropic liquid crystals when mixed with a polar solvent such as water. Addition of ethanol in small concentration to a water/GMO system reduces viscosity, however, in case large amounts of ethanol are added the ordered structure is distorted and the liquid may separate into two phases. It should be understood that addition of ethanol in small concentration to a water/GMO system reduces viscosity, however, in case large amounts of ethanol are added the system adopts a micellar structure by first separating into a two phase region in the ternary diagram followed by the formation of the micellar region.

As demonstrated in the ternary phase diagrams 10 (FIG. 1A) and 60 (FIG. 1B), the cubic phase exists only when the amount of the ethanol is low (in the region of about 10% in FIGS. 1A and in 1B). The microscopic structure of the formed liquid crystal transforms as a function of the temperature. At 25° C. it may exist as a lamellar or cubic phase while at 80° C. it is in the hexagonal phase. Along the GMO-water axis 70, with no ethanol, a lamellar (L_{α}) phase exists in case the water concentration is up to 17% 80. As the concentration of water is increased, i.e. at 25% wt water a cubic phase predominates at 90. Upon addition of ethanol, the lamellar phase predominates 80 although also at certain relative concentrations of the three components a cubic phase also exists. Each of these lamellar and cubic phases is well defined and characterized by its X-ray diffraction (after the appropriate dispersion).

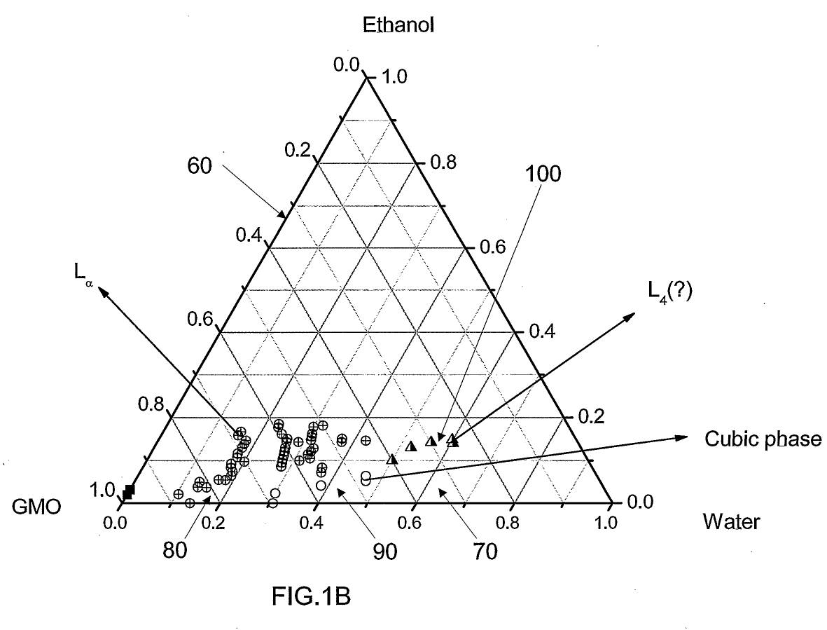

At a water concentration in the range of 40% to 65% water, 25% to 60% fatty acid or an ester thereof and 4% to 20 of an alcohol or ketone a unique new “semi-ordered” stable single phase system exists 100. This new isotropic region, termed Q_{L} although forms spontaneously in a region close to the cubic phase, does not have cubic phase physical properties and is surrounded by a non-isotropic two phase regions. Turning to FIG. 2, the boundaries of the unique single Q_{L} phase of the invention were more closely defined. In particular, the effect of addition of water on the phase behavior of the ternary mixtures at constant concentration of 10 wt % alcohol was elucidated. Along the parallel line starting at 9:1 GMO/water increasing amounts of water were added. The examined points were marked as samples A to H (FIG. 2). Photomicrographs of the samples were taken (data not shown). Sample A contains 10 wt % water, 10 wt % ethanol and 80 wt % GMO. The sample is somewhat turbid but without any visible separation onto two phases. Light microscope (data not shown) showed sharp and strong typical lamellar-type of birefringency. Sample A is very close to the lamellar region and is most probably ill-defined lamellar. SAXS measurement (data not shown) exhibited a single one peak diffracting reflections evidencing very large domains of most probably ill-defined lamellar structure. Samples B and C are richer in water (20 and 30 wt % water, respectively) and are located within the lamellar region. They are homogeneous and almost clear. Microscopic observation revealed typical lamellar structures (data not shown). SAXS (data not shown) showed structuring with defined 1:2 space ratios and mean cell units of 49.5 and 41.4 Å. Such unit cells indicate swelling by water of the lamellar layers. This is a typical behavior of swollen lamellar mesophases. In sample D (40 wt % water) it was found that there exist two phases, the upper (Dᵤₚₚₑᵣ) is slightly opaque and turbid and the lower (D_{lower}) is a clear non-viscous phase. Microscopic observations confirm that the Dᵤₚₚₑᵣ phase is lamellar and the D_{lower} is non-birefringent. SAXS measurements (data not shown) confirmed the structures. The upper phase is typical lamellar with first and second order peaks obeying 1:2 relationship. Calculated values of the lamellar lattice periodicity spacing are 49.1 Å. This value is somewhat larger than the values obtained by Briggs (Briggs, J. Chung, H., Caffrey, M. J. Physique II (1996) 6, 723-751) for binary mixture. Briggs calculated values of 35.6-42.3 Å for a system having 4.7-15.2 wt % GMO in the GMO/water mixtures at 25° C. (Briggs 1996). The values which were found are some what larger because the ethanol spaces them out. It should be stressed that the ethanol allows higher hydration values i.e. more water is hydrating the head groups as is reflected in the larger spacing (49.1 Å in our ternary mixtures vs. 35.6-42.3 Å in the binary mixture). However, once maximum hydration is reached the lamellar layers can not further swell and phase separation occurs. Therefore, sample C and sample D will have similar spaces. However, while sample C is one phase, sample D will separate into two phases. The lower phase (D_{lower}) is clear non-viscous with SAXS diffraction similar to cubic phase. The calculated lattice parameter is α=125.9±0.0002 Å and this is in the range of lattice parameter of micellar cubic phase. The above-mentioned calculation defines a space group of the cubic phase but even with the very good fit to all the Bragg peaks we could determine the existence of group of Pm3n which was observed in system of micellar cubic phase. The deviation from the Pm3n is due to the absence of √12 and √13 reflections these small peaks can indicate on local ordering or micro domains of the micelles with specific structure (with shape and size).

Sample E is a single clear and transparent liquid phase of high thermodynamic stability and low viscosity. Sample E represents a unique compositional situation. The ethanol:GMO ratio is 1:4 and the water:GMO weight ratio is 5:4. The water and the alcohol play a key role in the formation of “swollen cubic phase” that self-assembles in micelles closely packed into cubic symmetry, but spaced enough to disrupt the classical cubic phase. It results in a formation of liquid-like single phase of unique properties. The E sample is dark at cross polarized light with no birefringency. It has Bragg diffractions with similar pattern to the pervious sample D_{lower}, but consists of lower number of diffractions with high intensity and more separated diffraction exhibiting higher crystallinity and more internal order. Close examination of the diffractions reveals the existence of a series of 16 Bragg peaks with calculated reciprocal spacing ratios of √2, √4, √4, √6, √7, √10, √11, √13; √14; √16; √18; √19; √20; √√21; √22; √√24. Plotting the reciprocal d space (1/dₕₖₗ) of the all 16 reflections versus (h²+k²+1²)^{1/2} is intercepting the axis of the origin with very small deviation of 0.00031 and high linearity 0.99973. Despite the existence of 16 Bragg peaks, the space group is not simply defined due to the fact that the 6 first spacing ratios were almost identical to the Pm3n space group. The only space ratio that is absent is √8 where a √7 spacing ratio was found. Spacing ratio √7 is typical to hexagonal spacing, however it was already found in other cubic phase systems that the spacing ratio of √7 may exist {Lindblom et al. (1979), J. Am. Chem. Soc. 112, 5465-5470; Landh T., (1994) J Phys. Chem. 98, 8453-8467; and Edlund et. al., (1997) J. Colloid Interface Sci. 196, 231-240}. It should be noted that the inventors found √7 spacing ratio also in Gyroid symmetry, in system that included GMO/EtOH/water or GMO/water. According to Garstecki and Holyst (2002, Langmuir 18, 2529-2537) the existence of √7 might indicate mesostructures with mixed symmetries of cubic and some unknown phase. The √17 peak is missing but the √11, and √19 peaks are present. It should be noted that the peaks are very small and one can consider them as noise therefore the indexing is not definite. However, these spacing ratios might reflect on the coexistence of two or more types of domains. It should however be borne that the detected or assessed reflections give on average structure in case more then one type of domains coexist in the system (lower symmetry micellar structures and cubic micellar structures). Thus it is apparent that in spite of the existence of additional diffractions, the symmetry of the single unique phase at the region of the E sample (herein defined as Q_{L} phase) is of Pm3n, i.e cubic micellar structures. Such structures are the dominant mesostructures of the E sample. It should be understood that the mesophase may consists of some ill-defined not fully developed or fully organized cubic micellar structures i.e complexity structure like “transformed structures”. Alternatively, the phase may be a mixture of mainly cubic micellar phase with some less unorganized micellar system that might have some hexagonal resolution.

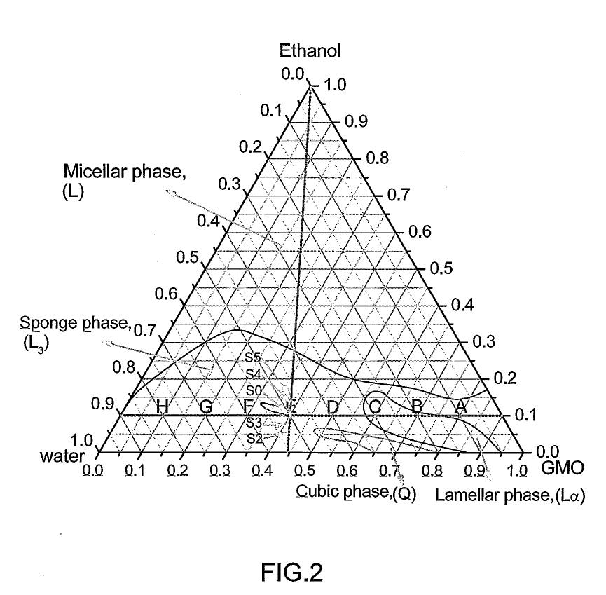

In order to better clarify the structure of the unique Q_{L} phase, Freeze-Fracture Electron Microscope (cryo-TEM) images were done. The images were performed on the Q_{L} phase and the resulting images were further tested with Fourier Transform (FFT) software. Turning to FIG. 3A there is shown a cryo-TEM micrograph of Q_{L} phase containing 40% GMO, 10% ethanol and 50% water. As apparent, the sample contains different levels of organization, some are well organized and the others are less organized. The image obtained after the FFT analysis is shown in FIG. 3B. The FFT image shows cubic organization, but the reflection is relative weak. The different organizations and structures weaken the FFT reflections. Upon close inspection of the cryo-TEM images one may identify different structures such as cubic, hexagonal, and micellar structures (FIG. 3B).

Turning to Sample F (displayed in FIG. 2), the sample consists of 30 wt % GMO; 10 wt % ethanol and 60 wt % water, and is outside the boundaries of the one phase region demonstrated in Sample E. Macroscopically the phase is a combination of two phases. Sample F did not clear upon storage thus in equilibrium it is a combination of two phases. It should be noted that Sample F has exactly the same alcohol content as sample E but the alcohol:GMO ratio is higher being 1:3 (1:4 in sample E), however, relatively poorer in water where the water:GMO ratio is 2:1 (5:4 in sample E). The two phases within the Sample (upper and lower) are dark and non-birefringent. The Flower phase contains mostly water with some ethanol, while the Fᵤₚₚₑᵣ has less diffraction peaks than sample E. The diffraction peaks are √2; √4; √5; √6; √8; √10 and under indexing and plotting the 1/dₕₖₗ (h²+k²+1²)^{1/2}, typical cubic linear line is obtained with R=0.99952 and deflection from the origin is of 0.0002. The lattice parameter was found to be α=130.9±0.0002 Å. Here again the fit is excellent reflecting the existing of Pm3n symmetry. This cubic phase, Pm3n is based on packing of discrete micellar and it observed in other system only in appearance of type I e.g. oil-in-water (Delacroix H,. et al. (1996) J. Mol. Biol. 258, 88-103). Based on the microscopic topology view of the nonlamellar phases in the GMO-water system, it may be suggested that the structure consists of water-containing micelles embedded in a hydrocarbon matrix. In the lower phase no definite structure could be elucidated. It should be stressed that the Fᵤₚₚₑᵣ phase is a liquid non-viscous sample having very similar rheology properties to that of sample E. Sample G has different macrostructure. A piece of gel floats in an alcohol/water continuous phase. The “gel” is very similar to the classical cubic phase. Turning to sample H, the sample consists of a composition comprised of GMO:EtOH:water in a ratio of 10:10:80 wt % respectively. The GMO:ethanol ratio is 1:1 (no excess of ethanol in the water) and the sample appearance is of a gel block floating into a large amount of water continuous phase. The “gel-phase” Was analyzed by SAXS (data not shown). The reflections are sharp with high intensities very similar to classical cubic phase of GMO/water mixtures (√3√;4√;6;√8; √9; √11; √12) corresponding clearly to Pn3m space group suggesting the existence of C_{D} (diamond) type bicontinuous cubic phase with good agreement with the Pn3m symmetry that was found for GMO/water mixtures with >25 wt % water. The lattice parameter was found to be α=130.5±0.0004 Å. The lattice parameter with alcohol is larger than that of the binary mixture (102.1-101.8 Åof 36.1-43.6 wt % water at 25° C. (Briggs, 1996)). It should be noted that the occurrence of micellar phase in the transformation from the lamellar phase to bicontinuous cubic phase might suggest that the system can transform in several paths between lamellar and bicontinuous phases depending on presence and the amount of co-solvent (ethanol in the instant case).

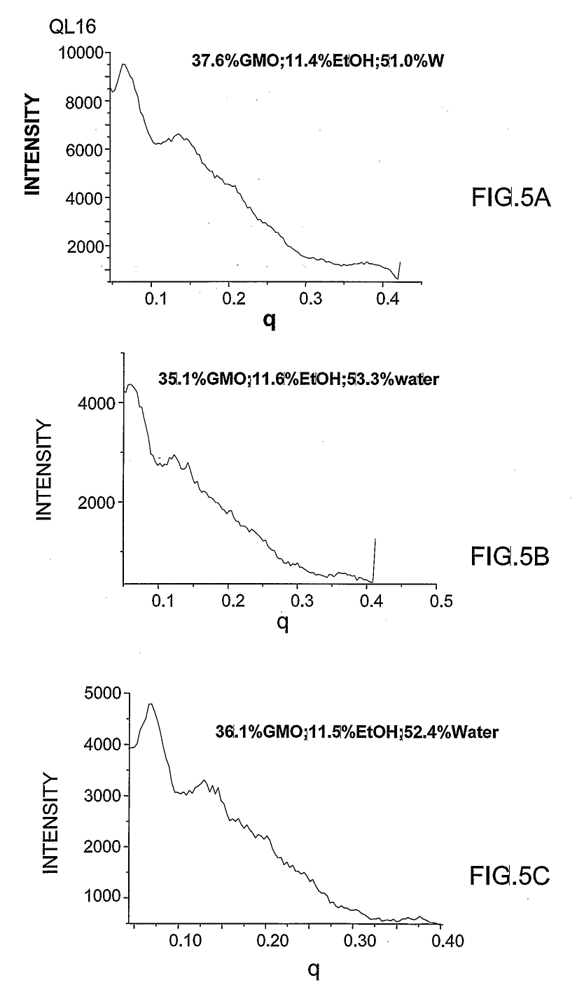

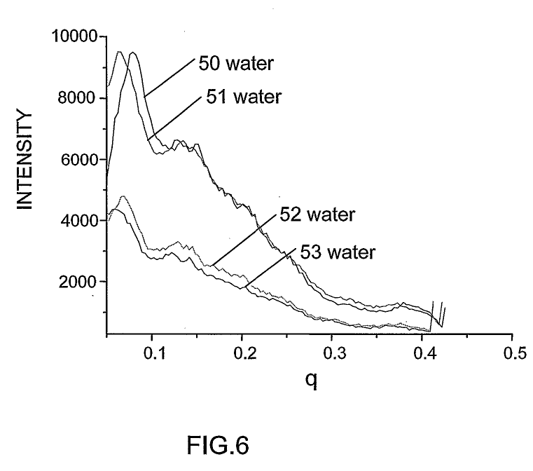

In order to further clarify the unique isotropic cubic-like Q_{L} phase additional three compositions within this Q_{L} phase were further studied where their SAXS diffractions are shown in FIG. 5A-5C. The water content of the composition in 5A is 51.0 wt %; 11.4 wt % ethanol; and 37.6 wt % GMO. The water content of the composition in 5C is 52.4 wt %; 11.5 wt % ethanol; 36.1 wt % GMO. The water content of the composition in 5B is 53.3 wt %; 11.6 wt % ethanol; 35.1 wt % GMO. The samples differ only slightly from each other in their compositions and SAXS diffraction pattern. The SAXS diffraction patterns contain one peak in the relative small q value with relative high intensity and a shoulder in higher q value. Actually this shoulder is composed of several peaks with lower intensities. Comparison of the SAXS diffractions of 4 compositions having 50, 51, 52 and 53 wt % of water are shown in FIG. 6. Table 3 summarizes the relative data from the Q_{L} region.

TABLE 3

| | | Lattice parameters - |
|---|---|---|
| GMO:ethanol:water | Observed reflections | α (Å) |
| 37.6:11.4:51.0 | √3; √5; √10; √15; √20; | 182.5 |
| 36.1:11.5:52.4 | √2; √3; √7; √8; √11; √12; | 161 |
| | √13; √18; √20; √24; √26; | |
| 35.1:11.6:53.3 | √3; √6; √11; √13; √16; | 184 |

From close examination it can be seen that the reciprocal spacing ratios are not repeated in the samples from the Q_{L} region. The complexity is caused by the fact that most of the peaks are small, and not detectable resulting in smaller number of reflections which despite the difficulties obey the cubic symmetry. In addition, some of diffraction peaks may be pilled up and remain unresolved. Furthermore, the difficulties in analyzing crystallography of micellar cubic phase are known. The interlayer spacing in samples with >10 wt % ethanol in Q_{L} region is significantly larger (161-184 Å) than the bicontinuous cubic phase (100 Å of 3 wt % ethanol). From these results we can understand that the initial bicontinuous cubic phase disappears and the system forms discrete micellar structure.

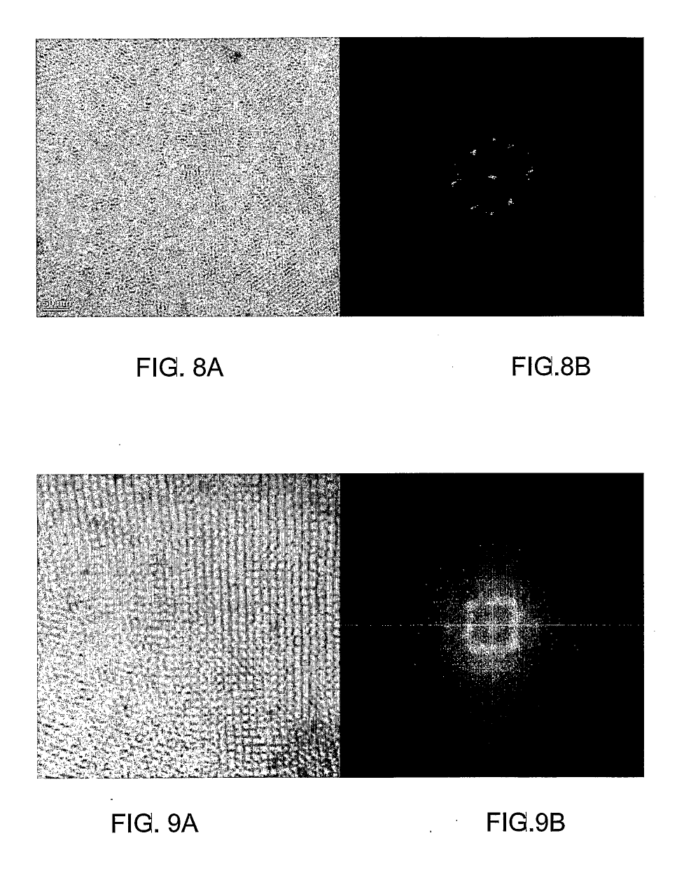

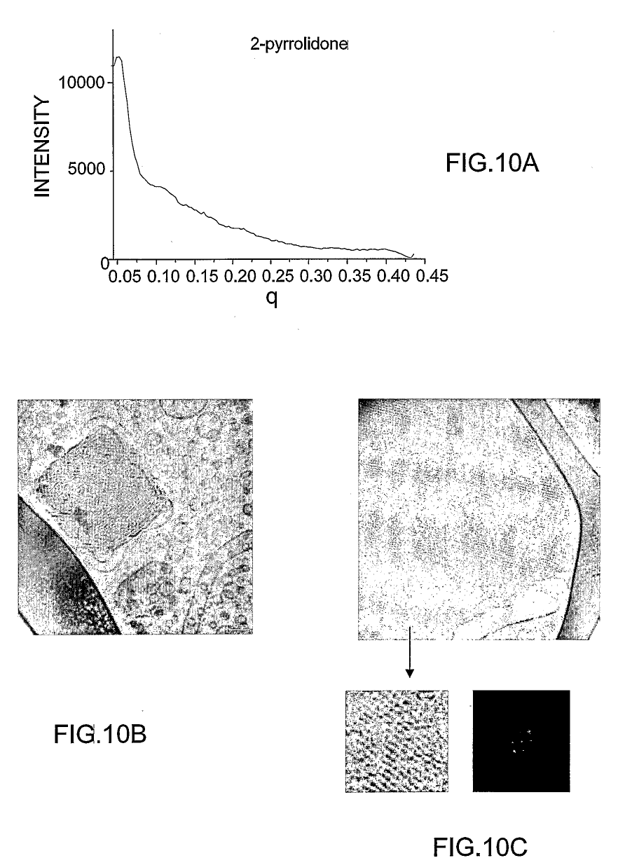

Useful techniques in determining a cubic structure is the cryo-TEM technique. FIG. 8A shows micrograph of Q_{L} phase containing 36.1% GMO; 11.5 wt % EtOH; 52.4 wt % water. The respective micrograph showing the Q_{L} phase containing 38.3 wt % GMO; 11.2 wt % EtOH; 50.5 wt % water are shown in FIG. 9A. The FFT results (FIGS. 8B and 9B) show cubic organization. The sample richer in GMO (9B) seems to be more organized.

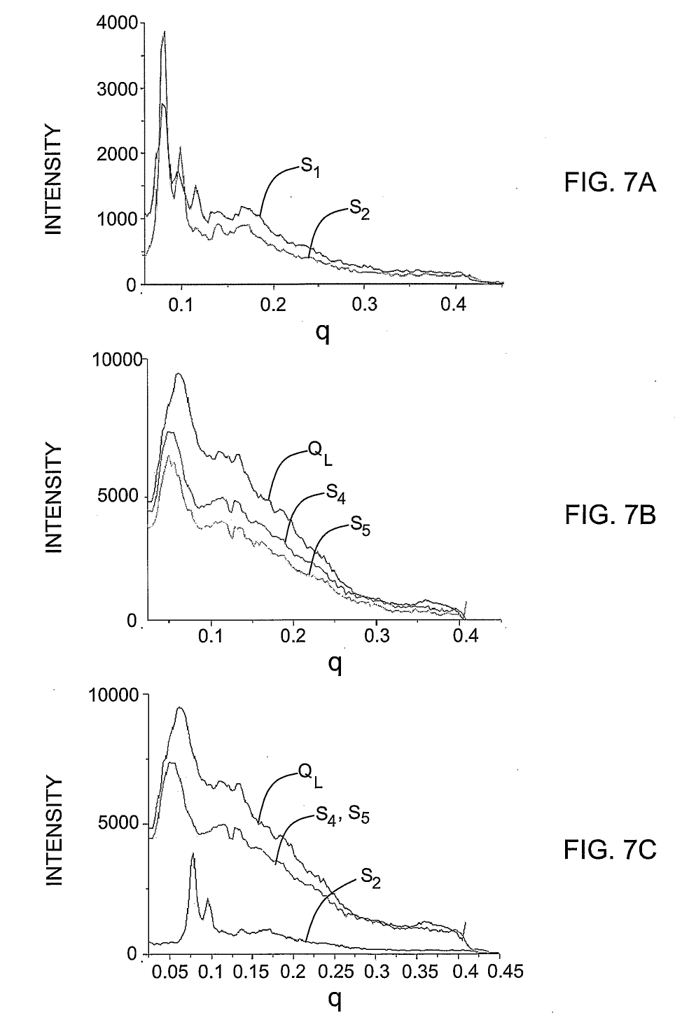

The effect of the co-solvent, ethanol in the present case, on the phase behavior of the ternary mixtures was elucidated holding constant the GMO:water concentration. The constant concentration was at 1:1.2, where Ws and Ww are the weight fractions GMO (surfactant) and water, respectively (40:50). The examined points were marked S₂ to S₅ (FIG. 2) where the S₀ is the Q_{L} phase of the present invention. Samples S₂, S₃, S₄ and S₅ all consist of two phases wherein the S₀ sample (the Q_{L} region) displays one single isotropic phase. These samples can be divided into two groups with respect to the ethanol content (reflected also in their microstructure), one category is samples with less than 10 wt % ethanol and the other category is the samples with more then 10 wt % ethanol (“under” and “above” the Q_{L} region). The sample S₂ contains 44.2 wt % GMO, 5.8 wt % ethanol, and 50.0 wt % water and the S₃ sample contains 42.4 wt % GMO, 7.6 wt % ethanol, and 50.0 wt % water. These two samples show two phases turbid gels (one phase) with excess water (the other phase). The cross-polarization microscopic observation reveals non-birefringent structures. SAXS measurements of the gel phase showed pattern similar to bicontinuous cubic structure (FIG. 7a). The reciprocal spacing ratio of S₂ are: √2; √3; √4; √6; √8; √9; √10; √11; √14 corresponding to Pn3in space group (√12 could not be seen), which suggests formation of C_{D} type bicontinuous cubic phase. Such spacing are expected to be formed in the binary GMO/water system and must be present in the ternary system as well, either as one- or two phases regions as a consequence of Gibb's phase rule. In the presence of higher ethanol content (7.6 wt %) as in the S₃ sample, the macro and microscopic appearance is similar to S₂ (as in FIG. 7A) but nonidentical. Picks with ratios of √2; √3; √4; √5; √6; √7; √8; √9; √12; √13; were detected which reflect deviation from Pn3m space group by two unseen diffraction peaks √10 and √11 and the ratios are complicated since two diffraction peaks √5 and √7 do not obey to the Pn3m space group. These diffraction peaks better correspond to P4₂32 space group, mainly because of the existence of the √5 reflection. The existence of (h²+k²+1²)^{1/2} of √7 appears many times in indexing of the diffractogram of a variety of systems in cubic symmetry.

Turning to the S₄ sample, the composition comprises 39.2 wt % GMO, 12.4 wt % ethanol, and 48.3 wt % water. The S₅ sample comprises 38.0 wt % GMO, 15.2 wt % ethanol, and 46.9 wt % water. Samples (S₄, S₅) are separated into two phases, the upper phase is turbid and the lower phase is a transparent liquid. Both lower samples (lamellar) are non-birefringent (isotropic phases). SAXS measurements showed pattern similar to Q_{L} structure (FIG. 7B) but very different from the diffractogram pattern of the sample with lower ethanol content (S₂ see FIG. 7C). The S₄ and S₅ reflections reveal low intensity peaks in the low q value, similar to S₀ sample. The observation of an extra reflection indicates the influence of the ethanol on the restructure of the cubic phase into micellar organization. The reciprocal spacing ratio of S₄ sample are √2; √3; √7; √9; √13; √14; √24; √28 and of S₅ sample: √3; √4; √7; √12; √14; √16; √19; √23; √30; √33. These indexing although with excellent fit of the diffractograms are difficult to interpret. The q values are shifted to lower values as the ethanol content increases, 0.0800, 0.0558 and 0.0491 Å respectively.

It should be understood that in general the co-solvent, e.g. ethanol, allows the existence of continuous cubic organization up to approximately 1 part ethanol per 6 parts of water. At higher ethanol content or lower ethanol:water ratios the structure transforms to a discrete structure probably in a cubic symmetry. Such transformations are known (with restriction) of the bicontinuous cubic phase with Pn3m space group to discrete cubic phase with space group Pm3n observed in GMO/water under hydrostatic pressure (1-1.5 kbar). Ethanol is a polar solvent completely miscible with water. Therefore it can be localized both on the interface (affecting the structure) or on the continuous phase (no affect). The presence ethanol causes a disorder of the bicontinuous joints (connection points) but practically does not affect the curvature. The ethanol concentration is thus an important factor affecting the d-value which is characteristic of the cubic phase. Cubic continuous phase in presence of the small amount of ethanol have diameter of 107 and 117 Å and it is a slightly larger than the bicontinuous cubic phase at a system consisting of only GMO/water. An increase of ethanol concentration results in the formation of discrete or micellar cubic phase and a transform from bicontinuous cubic phase to micellar phase.

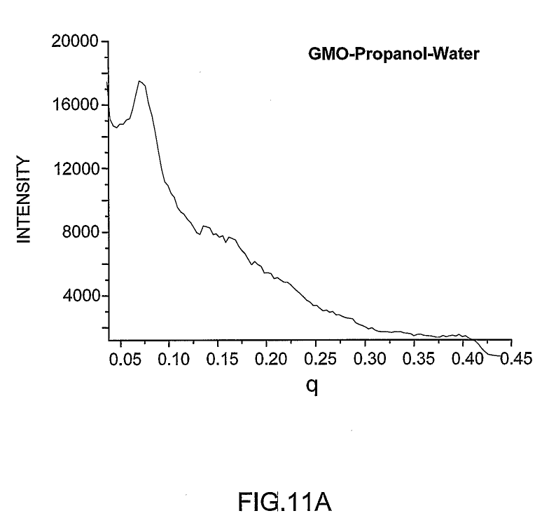

A ternary system comprised of 2-pyrrolidone:water:GMO also displays the same unique Q_{L} phase as displayed in FIG. 10. FIG. 10A displays the SAXS of the system (example 3) comprised of 2-pyrrolidone:water:GMO in a ratio of 20:50:30 wt %. The formed Q_{L} phase was dispersed in a water/polymer system and a cryo-TEM micrograph of a selected enlarged portion is shown in FIG. 10B where FIG. 10C shows the cryo-TEM micrograph of the system and its FFT analysis showing the cubic symmetry.

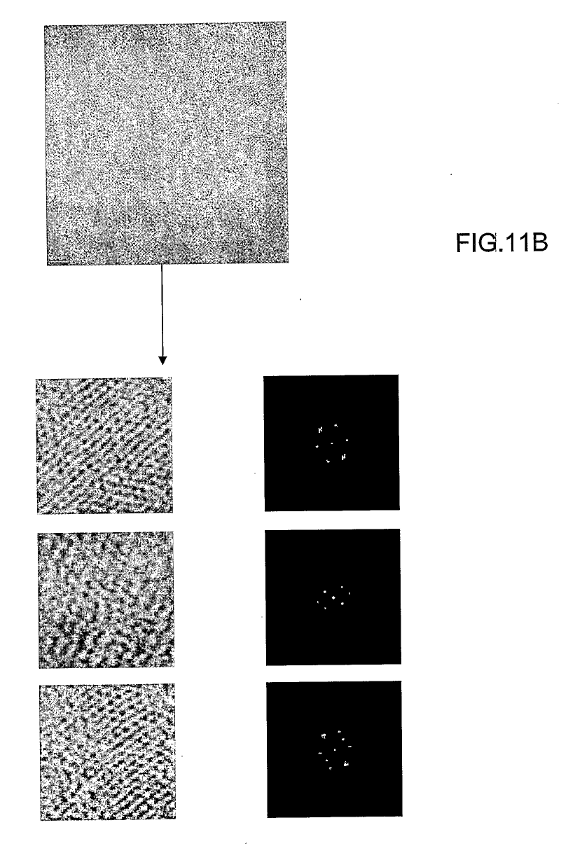

Another ternary system (example 2) displaying the unique Q_{L} phase is displayed in FIG. 11. The system is comprised of propanol as the co-solvent where the propanol:water:GMO ratio is 8.3:55.1:36.6 wt %. FIG. 11A displays the SAXS characterizing the Q_{L} phase having the unique cubic symmetry. FIG. 11B displays the cryo-TEM micrograph and its FFT analysis demonstrating the cubic symmetry.

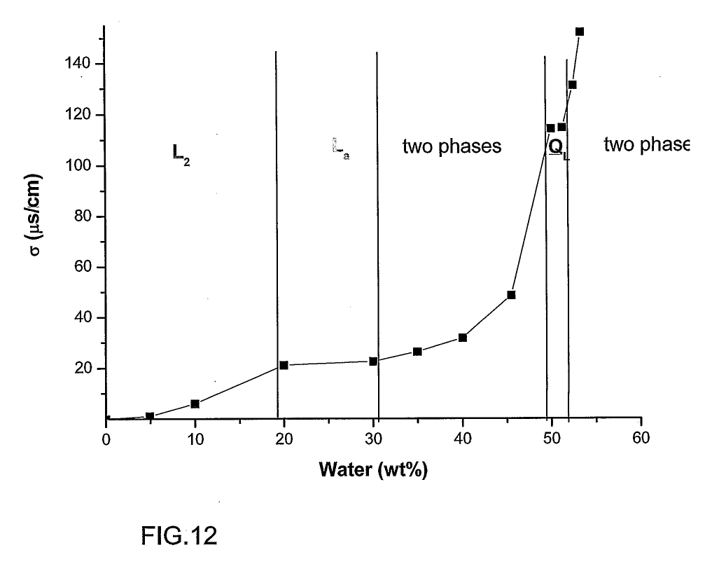

The isotherm of electrical conductivity versus water content in dilution line 8:2 is shown in FIG. 12. Generally, the conductivity values increase as the water content increases. Furthermore, within close values of water concentration, the conductivity changes upon transfer of the system from one phase to a different phase (corresponding well with the phase diagram areas). In the micellar phase (L₂ phase region) the conductivity is relatively very low and does not exceed 10 μS/cm and progressively increases as the water content increases. It is well-known that nonionic surfactant with discrete reverse micelles have electrical conductivity (σ) similar to that of the continuous phase. Isolated droplets in a nonconducting GMO medium have little interaction with each other (data not shown). Lamellar phase having a water content between 20-30 wt %, also have low electrical conductivity, which does not exceed 22.5 μS/cm, suggesting that the lamellar phase is composed of a stacked bilayers of alternating layers of ordered surfactant molecules and solvent. The surfactants in the bilayers are organized so that the hydrophobic tails of the surfactant molecules are at the center of the lamellar and the hydrophilic parts of the molecules are in contact which the solvent layer. Hence the conductive solvent is connected to the hydrophilic parts and is isolated from the hydrophobic tail, giving rise to low conductivity values. In the lamellar phase range the conductivity change is negligible or almost plateau which can indicate that all the water electrolytic is occupied or connected to the hydrophilic region. The conductivity values rise again as the water content increases. In a system having 30-50 wt % water contents the surfactant is structured (fully hydrated) leading to phase separation. The change of the slope beyond 45 wt % water can indicate a rupture in the bicontinuity of the lamellar structure and the formation discrete micellar structure, in agreement with the SAXS measurements. At water levels of 50-53 wt % the electrical conductivity remains almost unchanged ca. 114 μS/cm and the system contains again only one phase (the Q_{L} phase).

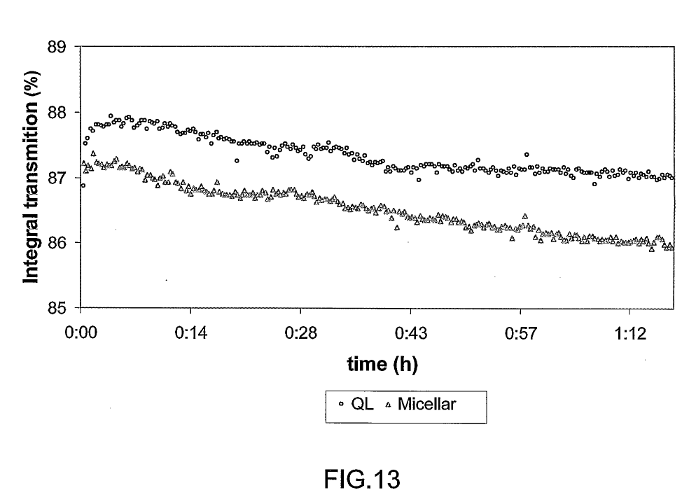

Turning to FIG. 13, the stability of Q_{L} phase was examined by LUMiFuge instructor where the stability was compared to that of a micellar phase. As demonstrated in the figure, the Q_{L} phase has stability comparable to that of a micellar phase. The LUMiFuge is an analytical centrifuge. The principle of functionality is based on a continuous definition of the light transmission of the analyzed specimen (the particular analyzed system) over the total length of the measurement cell. The resulting transmission profile shows the intensity of the light transmitted as a function of the radial co-ordinates. The radius specifies the distance from the center of the rotor. The measurement taken by the instrument resemble the shelf life of the tested specimen, which amounts to the time that the system (phase) should separate, hence it is an indicator of the stability of the system.

The invention, therefore, concerns ternary systems comprising water, fatty acid or an ester thereof and a co-solvent which is an alcohol, a ketone, amino acid or organic acid. Such a system forms spontaneously a stable, non-viscous and clear nanosized structures having cubic-like nanosized symmetry. Macroscopically, the system is an oil-like phase. The physical properties of this new single phase region are very unique and different than the previously known cubic phase. The phase is fully clear and transparent (not tinted), non-birefringent, very fluid and of low viscosity, isotropic flowable liquid and very stable at room temperature. The single phase was found to be stable upon storage for nearly a year without any physical changes. The fatty acid is a C₂-C₂₂ preferably C₈-C₁₈ saturated or unsaturated fatty acid wherein the unsaturated fatty acid may contain one or more double bonds. Most preferably it is C₁₀-C₁₆ saturated or non-saturated fatty acid. The fatty acid ester may be with a regular alcohol or a polyalcohol such as glycerol, sorbitol, propylene glycol, polyglycerol, sorbitan, polyethylene glycol. Preferably it is glycerol esters of fatty acids. Most preferably it is glycerol monooleate or a mixture of monooleate and monostearate or any partially hydrogenated monoglycerol of vegetable oils. The alcohol used as a diluting solvent for the water/fatty acid or its ester may be a C₁-C₈ alcohol or a polyalcohol. Preferably it is ethanol, propanol or butanol or polyethylene glycol. In a preferred embodiment where the alcohol is ethanol and the fatty acid is in the form of an ester, glycerol monooleate, the relative concentrations of each component yielding the semi-ordered phase is 40% to 65% water, 25% to 60% fatty acid or its ester and 6% to 22% ethanol. The stability of the Q_{L} phase was tested at a temperature range of 15 to 33° C. for nearly a year maintaining it stability. Lowering the temperature (to about 7° C.) causes a change evident by the formation of turbidity. However, the change is reversible and raising the temperature yields once again the clear oil-like Q_{L} phase.

It should be noted that the spontaneously formed Q_{L} phase system is capable of being diluted or dispersed in an excess of a water/polymer system at room temperature by merely dilution of the phase with an appropriate system to form cubosomes. Such a dilution or dispersion of the oil-like Q_{L} phase in a water/polymer system exhibits a stable solution and does not rupture the microscopic internal bi-continuous cubic ordered structure. Alternatively, it may be dispersed by applying on the phase mechanical or ultrasonic energy together with addition of a water/polymer diluting solution (excess of water). Usually about 200-20000 rpm preferably 9000 rpm were used to form dispersed cubic-like nanosized particles. The polymers used in both techniques of dilution or dispersion may be a high molecular weight amphiphilic synthetic or naturally occurring polymer such as a specific protein or hydrocolloid or a mixture thereof. A polymer of appropriate length and molecular weight should be used. Non limiting examples of a synthetic polymer are PEG-100, PEG-60. A naturally occurring polymer may be β-casein. The former method for forming cubosomes by merely adding a polymer and/or water rather than subjecting the phase to a mechanical or ultrasonic energy is preferable since the exerted mechanical force may degrade the cubic structure. Compared to the cubosomes which are formed by dispersing cubic phase particles of the prior art (40 and 50 in FIG. 1A), the Q_{L} phase of the present invention is thermodynamically very stable. Thus the Q_{L} phase of the present invention has three major advantages over the cubosomes of the prior art. It does not have to be diluted prior to its use since it is an oil-like phase as opposed to the gel-like phase of the liquid crystalline cubic phase. In case dilution is desired, it may be done at room temperature with no need of any shear force. Furthermore, it is stable for longer periods of time, e.g. a year.

Well ordered liquid crystals have many applications all utilizing their relative structured character and the very large surface area they posses. The fact that the Q_{L} oil-like semi-ordered phase of the present invention may be used as is with no need to further dilute it is a big advantage for its use as a solubilizing medium. It thus may be used as is for solubilizing hydrophilic and hydrophobic compounds such as enzymes, vitamins, food supplements, pharmaceuticals or dyes, antioxidants, perfumes, cosmetoceuticals or peptides. Lycopene, β-carotene and leutin, all being hydrophobic food supplements as well as the medicament carbamazapine were all successfully solubilized in an aqueous phase comprising of the Q_{L} semi-ordered phase having a water/GMO/ethanol relative concentration of 50%/40%/10%. Likewise, ascorbic acid, a hydrophilic vitamin was also successfully solubilized in such a water/GMO/ethanol system of the present invention.

### EXPERIMENTAL

### Example 1

### Formation of a Q_{L} “Semi-ordered” Phase with Ethanol

2 gr of GMO were melted by heating to about 50° C. In a separate vessel, the 2 gr of GMO and 0.5 gr of ethanol were placed. The vessel was closed and its contents were mixed well with vortex for several minutes. The vessel was placed in a bath at 45° C. To the vessel was added 2.5 gr water. Following the addition of the water the mixture appeared to be white. The mixture was stirred and allowed to stand at room temperature, where after several hours all the foam disappeared and the sample became transparent. The composition comprised 50% water, 40% GMO and 10% ethanol.

### Example 2

### Formation of a Q_{L} “Semi-ordered” Phase with Propanol

The formation of a semi-ordered Q_{L} phase was done as in example 1 wherein the alcohol is propanol. The composition comprised 55.1% water, 36.6% GMO and 8.3% propanol.

Example 3

### Formation of a QT “Semi-ordered” Phase with 2-pyrrolidone

The formation of a semi-ordered Q_{L} phase was done as in example 1 wherein the alcohol is 2-pyrrolidone. The composition comprised 50% water, 30% GMO and 20% 2-pyrrolidone.

### Example 4

### Solubilization of Lycopene in a QT Semi-ordered Phase

2 gr of GMO were melted by heating to about 50° C. In a separate vessel, 2 gr of GMO and lycopene (0.0085 gr) were placed. The vessel was closed and its contents were mixed well with vortex until all the lycopene dissolved. 0.5 gr ethanol was added and the combination further mixed. The vessel was placed in a bath at a temperature of 45° C. 2.5 gr water were added. Following the addition of water the mixture appeared white. The contents were further mixed and left to stand at room temperature where after several hours all the foam disappeared and the sample became transparent.

### ExampleS 5 & 6

### P-caroten and Lutein were Solubilized in a Similar Manner as Lycopene.

### Example 7

### Solubilization of Ascorbic Acid in a QT Semi-ordered Phase

2 gr of GMO were melted by heating to about 50° C. In a separate vessel, 2 gr of GMO and 0.5 gr of ethanol were placed. The vessel was closed and its contents were mixed well with vortex. The vessel was placed in a bath at 45° C. To the vessel was added 2.5 gr water containing ascorbic acid (0.0166 gr). Following the addition of the water the mixture appeared to be white. The mixture was stirred and allowed to stand at room temperature, where after several hours all the foam disappeared and the sample became transparent.

### Example 8

### Solubilization of Carbamazepine in a O_{L} Semi-ordered Phase

2 gr of GMO were melted by heating to about 50° C. In a separate vessel, 2 gr of GMO and carbamazepine (0.044 gr) were placed. The vessel was closed and its contents were mixed well with vortex until all the carbamazepine dissolved. 0.5 gr ethanol was added and the combination further mixed. The vessel was placed in a bath at a temperature of 45° C. 2.5 gr water were added. Following the addition of water the mixture appeared white. The contents were further mixed and left to stand at room temperature where after several hours all the foam disappeared and the sample became transparent.

### Example 9

### Solubilization of Phytosterol in a QT Semi-ordered Phase

2 gr of GMO were melted by heating to about 50° C. In a separate vessel, 2 gr of GMO and phytosterol (0.2 gr) were placed. The vessel was closed and its contents were mixed well with vortex until all the phytosterol dissolved. 0.5 gr ethanol was added and the combination further mixed. The vessel was placed in a bath at a temperature of 45° C. 2.5 gr water were added. Following the addition of water the mixture appeared white. The contents were further mixed and left to stand at room temperature where after several hours all the foam disappeared and the sample became transparent.

1. A ternary system comprising:
(i) 40 to 65% water;
(ii) 6 to 22% alcohol or a ketone; and
(iii) 25 to 60% a fatty acid or an ester thereof.
forming spontaneously a stable, non-viscous and clear nanosized structures having cubic-like nanosized symmetry.

2. A ternary system according to claim 1 wherein said alcohol is a C₁-C₈ alcohol or polyalcohol.

3. A ternary system according to claim 2 wherein said alcohol is selected from the group consisting of ethanol, propanol, butanol, pentanol, hexanol, heptanol or octanol and wherein said polyalcohol is polyethylene glycol, propylene glycol, glycerol, sorbitol, manitol, fructose, sucrose, polyglycerol, or xylitol.

4. A ternary system according to claim 1 wherein said fatty acid is C₂-C₂₂ preferably C₈-C₁₈ and most preferably C₁₂-C₆ saturated or unsaturated, said unsaturated fatty acid having at least one double bond.

5. A ternary system according to claim 1 comprising a fatty acid ester.

6. A ternary system according to claim 5 wherein said fatty acid ester is glycerol ester preferably glycerol monooleate.

7. A ternary system according to claim 1 wherein said ketone is a linear or cyclic C₃-C₈ ketone which may comprise a heteroatom such as nitrogen, oxygen or sulfur.

8. A ternary system according to claim 1 wherein said formed non-viscous and clear nanosized structures having cubic-like nanosized symmetry is capable of being diluted or dispersed in a water/polymer at room temperature and/or by subjecting the system to vibrations at 200-20000 preferably 9000 rpm to form dispersed cubic-like nanosized particles.

9. A ternary system according to claim 8, where said polymer is selected from the group consisting of high molecular weight amphiphilc synthetic or naturally occurring polymer.

10. A ternary system according to claim 9 wherein said natural occurring polymer is β-casein.

11. A ternary system comprising 45 to 55% water, 30 to 45% glycerol monooleate and 6 to 15% C₁-C₄ alcohol.

12. A ternary system comprising 45 to 55% water, 30 to 45% glycerol monooleate and 6 to 22% C₃-C₈ linear or cyclic ketone which may comprise a heteroatom such as nitrogen, oxygen or sulfur.

13. A stable ternary system comprising
(i) 40 to 65% water;
(ii) 6 to 22% alcohol or ketone; and
(iii) 25 to 60% fatty acid or an ester thereof,
forming spontaneously a stable, non-viscous and clear nanosized structures having cubic-like nanosized symmetry for use in solubilizing hydrophilic or hydrophobic substances in aqueous phase.

14. A ternary system according to claim 13 wherein said formed non-viscous and clear nanosized structures having cubic-like nanosized symmetry is capable of being diluted or dispersed in a water/polymer in room temperature and/or by subjecting the system to vibrations of 200-20000 preferably 9000 rpm to form dispersed cubic-like nanosized particles.

15. A ternary system according to claim 13 wherein said alcohol is a C₁-C₈ alcohol or polyalcohol, preferably selected from the group consisting of ethanol, propanol, butanol, pentanol, hexanol, heptanol or octanol; said polyalcohol is polyethylene glycol, propylene glycol, glycerol, sorbitol, manitol, fructose, sucrose, polyglycerol or xylitol; said fatty acid is C₂-C₂₂ preferably C₈-C₁₈ and most preferably C₁₂-C₁₆ saturated or unsaturated comprising at least one double bond; said fatty acid ester is glycerol ester preferably glycerol monooleate; said ketone is a linear or cyclic C₃-C₈ ketone which may comprise a heteroatom such as nitrogen, oxygen or sulfur.

16. A stable ternary system of claim 13, wherein said solubilized substances are chosen from the group comprising of enzymes, vitamins, pharmaceuticals, peptides, or food supplements.

17. A stable ternary system of claim 13, wherein said hydrophobic substance is lycopene, lutein, β-carotene, phytosterols.

18. A stable ternary system of claim 13, wherein said hydrophilic substance is ascorbic acid.
